(19) United States
(12) Patent Application Publication
(10) Pub. No.: US 2016/0123378 A1
(43) Pub. Date: May 5, 2016

(54) Torque Transmission Mechanism and Vehicle with a Drive Shaft

(71) Applicant: Bayerische Motoren Werke Aktiengesellschaft, Muenchen (DE)

(72) Inventors: Johannes MINTZLAFF, Hoehenkirchen-Siegertsbrunn (DE); Jan-Hinerk FRERICHS, Seesen (DE); Simon GAIL, Kempten (DE)

(21) Appl. No.: 14/996,261

(22) Filed: Jan. 15, 2016

Related U.S. Application Data
(63) Continuation of application No. PCT/EP2014/062614, filed on Jun. 17, 2014.

(30) Foreign Application Priority Data
Jul. 17, 2013 (DE) 10 2013 213 966.7

(51) Int. Cl. F16B 12/04

(52) U.S. Cl. CPC F16C 3/023; F16D 1/027; F16C 3/026

(57) ABSTRACT

A torque transmission device, includes an outer tube and an inner tube, which is inserted a certain distance into the outer tube. The outer tube is joined to the inner tube exclusively by way of a bonded joint in the torque transmission direction and in the longitudinal direction of the outer tube.

### CROSS REFERENCE TO RELATED APPLICATIONS

This application is a continuation of PCT International Application No. PCT/EP2014/062614, filed Jun. 17, 2014, which claims priority under 35 U.S.C. §119 from German Patent Application No. 10 2013 213 966.7, filed Jul. 17, 2013, the entire disclosures of which are herein expressly incorporated by reference.

### BACKGROUND AND SUMMARY OF THE INVENTION

The present invention relates to a torque transmission device and to a vehicle comprising a propeller shaft having the torque transmission device.

A torque transmission device having an outer tube, and an inner tube, which is inserted a certain distance into the outer tube, is known from DE 43 27 908 C1. There, a fiber composite tube is bonded to a connecting flange and a propeller shaft.

It is the object of the invention to create a torque transmission device that allows reliable torque transmission and has a defined failure behavior in the event of a crash.

This and other objects are achieved according to the invention by a torque transmission device having an outer tube and an inner tube. The inner tube is inserted a certain distance into the outer tube, and the outer tube is joined to the inner tube exclusively by way of a bonded joint in a torque transmission direction and in a longitudinal direction of the outer tube.

The starting point of the invention is a torque transmission device comprising an outer tube and an inner tube, which is inserted a certain distance into the outer tube. The outer tube and the inner tube can be components of a propeller shaft of a vehicle. The term “propeller shaft” here shall generally speaking be understood to mean a device that is coupled via a transmission output to an input of a final drive.

In the torque transmission according to the invention, the outer tube is connected to the inner tube by way of a bonded joint in the torque transmission direction, and, more particularly, exclusively by way of the bonded joint. The outer tube is thus not additionally rotationally coupled to the inner tube, for example by way of a form-locked torque connection or the like, but is exclusively integrally bonded by way of the bonded joint, which is comparatively cost-effective.

The adhesive layer turns the torque transmission device into a “crash element.” In the event of a crash, in which a force acting in the longitudinal direction of the inner or outer tube is exceeded, the bonded joint fails, whereby the inner tube is able to “telescope” at least a certain distance into the outer tube, which is to say is able to be inserted into the outer tube.

It is advantageous for the fatigue strength of such a torque transmission device if the torsional rigidity of the outer tube is approximately of “the same order of magnitude” as the torsional rigidity of the inner tube. The term “torsional rigidity” shall be understood to mean the product of the shear modulus G of the particular tube material and the torsional moment of inertia of the particular tube.

For example, it may be provided that the torsional rigidity of the outer tube is in a range of +/−10% of the torsional rigidity of the inner tube, or in a range of +/−5% of the torsional rigidity of the inner tube. The torsional rigidity of the outer tube is preferably exactly equal to the torsional rigidity of the inner tube. The torsional rigidities of the two tubes can be “adjusted” by the selection of the material, and by the tube diameter and the wall thickness of the particular tube.

When the torsional rigidities of the tubes are approximated, a similar torsion angle results for the two tubes under equal load. This results in an approximately linear progression of the torsional shear stress in the bonded joint. The bonded joint is thus equally loaded over the entire length thereof. Stress peaks would develop in the adhesive if the rigidity of the tubes with respect to each other were not considered. If such a stress peak were to cause the permissible shear stress/transverse stress of the adhesive to be exceeded, failure of the entire adhesive layer would have to be expected.

In addition to the properties of the adhesive, geometric relationships are also decisive for the function. In theory, the geometric influence on the tolerable axial force is limited solely to the adhesive surface. Since M=F*d/2, the geometric influence on the transmittable torque is additionally dependent on the tube diameter for the same adhesive surface. Starting at a certain shaft inside diameter, the tangential force resulting from the torque is lower than the transmittable axial force. This relationship favors setting of the axial failure force and thus the use of the bonding as the crash element.

According to a further aspect of the invention, it is provided that the inner tube is bonded across the entire outer circumference thereof to an inner circumference of the outer tube over a predefined adhesive length measured in the longitudinal direction of the inner tube or of the outer tube.

A high quality bonded joint requires a certain minimum thickness. To achieve this, a peripheral (groove-like) recess may be provided, for example, on an outer side of the inner tube, the recess being completely filled with an adhesive. As an alternative or in addition, a peripheral recess could be provided on an inner side of the outer tube, the recess being completely filled with adhesive.

Such a recess can be created, for example, by machining the tube in question by way of turning or milling.

For strength and/or centering reasons, it is advantageous if the outside diameter of the inner tube is identical to the inside diameter of the outer tube over the length thereof that is inserted into the outer tube, with the exception of the region in which the recess is provided. In this way, the inner tube is (“automatically”) centered in the outer tube.

To create the bonded joint, at least one through-hole opening into the recess can be provided in the outer tube. Adhesive can be filled into the recess via the through-hole when the bonded joint is being created (filling hole).

According to a further aspect of the invention, an adhesive that has low impact resistance is used. This is an essential difference compared to conventional glued tube joints. Conventional glued tube joints in general deliberately use adhesives having high impact resistance. The term “low impact resistance” shall be understood to mean that the adhesive embrittles and fails sooner at force gradients (increase in the force over time) in the range of those that occur during a crash than at force gradients that occur due to the torque to be transmitted.

The adhesive used may be a relatively liquid adhesive, which cross-links and expands when heat is supplied. Due to the expanding behavior of the adhesive, it is ensured that, once the adhesive has cured, the two tubes are integrally bonded to each other under a certain amount of stress.

The invention can be used in connection with different tube materials. For example, the outer tube can be a steel tube, a plastic tube, in particular a tube made of fiber-reinforced plastic material, such as a “carbon fiber-reinforced” tube. Different materials are also contemplated for the inner tube, such as steel, plastic material, fiber-reinforced plastic material, and in particular carbon fiber-reinforced plastic material.

If the outer tube is a fiber-reinforced plastic tube, it may be provided that fibers of the outer tube, in particular fibers located in the outer region of the outer tube, extend in the circumferential direction of the outer tube, similarly to a bandage, or in a direction that is oblique thereto along the circumference of the outer tube.

As was already mentioned, the invention can be used in particular in the vehicle field. The torque transmission device according to the invention can be used to join two tubes or tube sections of a propeller shaft of a vehicle, for example.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a force/path diagram of a conventional torque transmission device;

FIG. 2 is a force/path diagram of a torque transmission device according to an embodiment of the invention; and

FIG. 3 is a schematic cross-sectional representation of the basic principle of a torque transmission device according to an embodiment of the invention.

### DETAILED DESCRIPTION OF THE DRAWINGS

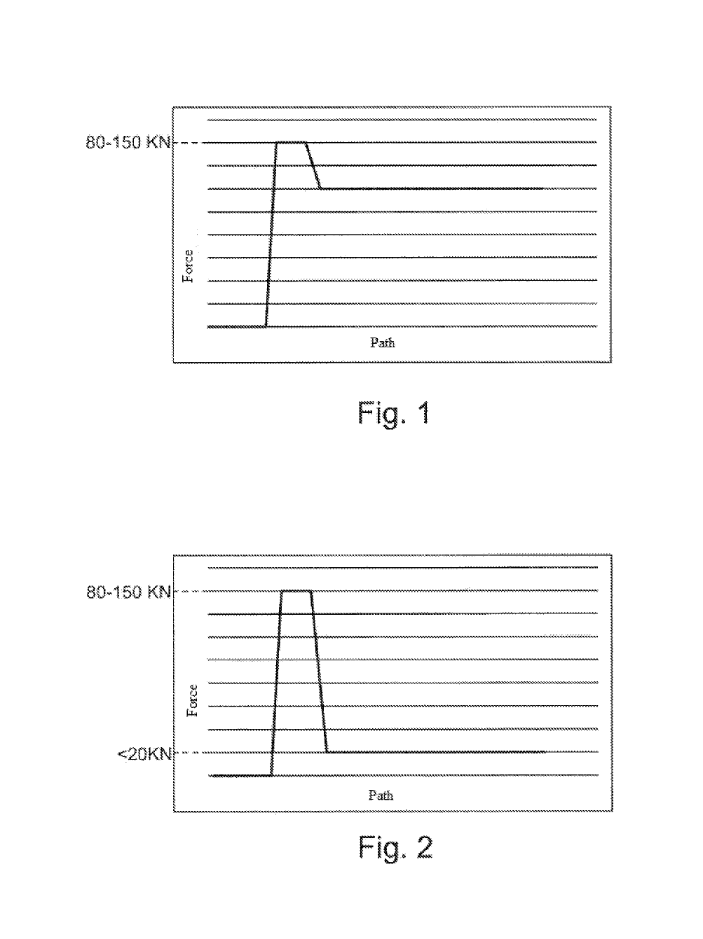

FIG. 1 shows a force/path diagram of a conventional propeller shaft in the event of a crash. In the event of a crash, the axial force acting in the longitudinal direction of the propeller shaft rises relatively suddenly from zero or a relatively low axial force to a value of 80 to 150 kN, which results in compression in conventional propeller shafts. The compression is associated with a certain, relatively small drop in the axial force.

A propeller shaft that comprises a torque transmission device according to the invention initially likewise exhibits a relatively sudden rise in the axial force to a level of 80 to 150 kN. The bonded joint then fails at a certain axial force, resulting in a relatively strong drop in the axial force to a value of less than 20 kN. This is due to the fact that, according to the invention, an outer tube and an inner tube of the propeller shaft, which inner tube is partially inserted into the outer tube, are bonded to each other by way of a bonded joint, the adhesive having low impact resistance.

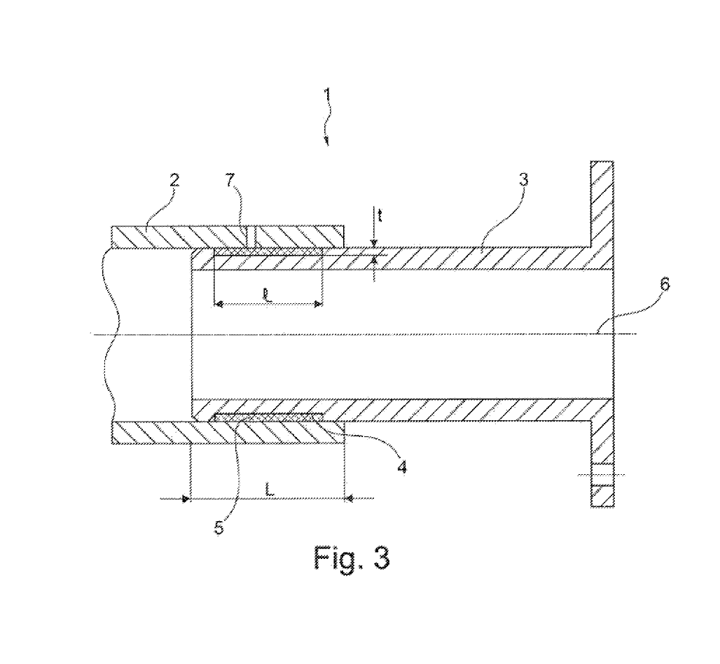

FIG. 3 shows a torque transmission device 1 according to an embodiment of the invention. The torque transmission device 1 includes an outer tube 2 and an inner tube 3, which is inserted into the outer tube 2 over a certain length L. A peripheral groove-like recess 4 is provided on an outer side of the inner tube 3 in the region of the length L. The recess 4 can have been created by way of turning or milling, for example. The length of the groove-like recess 4 measured in the axial direction is denoted by lower case 1, which corresponds to the length of the bonded joint.

The recess 4 is completely filled with an adhesive 5. By way of the bonded joint formed by the adhesive 5, the outer tube 2 is coupled, so as to be non-rotatable, to the inner tube 3 in the torque transmission direction (circumferential direction) and is additionally rigidly connected to the inner tube 3 in the axial direction 6. The bonded joint represents the only coupling in the torque transmission direction and in the axial direction. The inner tube 3 is not rotationally coupled to the outer tube 3 by way of an additional form-locked connection.

As is apparent in FIG. 3, the outside diameter of the inner tube 3 corresponds to the inside diameter of the outer tube 2 over the entire length L thereof that is inserted into the outer tube 2, with the exception of the region in which the recess 4 is provided. In this way, the inner tube 3 is centered in the outer tube 2.

When such a torque transmission device is produced, initially the inner tube 3 is inserted into the outer tube 2. Subsequently, the recess 4 is filled with adhesive via at least one through-hole 7 which is provided in the outer tube 2 and opens into the recess 4. For example, the adhesive 4 can be cured by supplying heat, whereby it is cross-linked and expands.

As an alternative to a liquid adhesive, it would also be possible to use a relatively solid adhesive, which is used to fill the recess 4 prior to inserting the inner tube. By supplying heat, it is also possible to cause “solid adhesives” to expand and cure.

The bonded joint can be designed so that the bonded joint fails exactly at the “interface” between the adhesive 5 and the inner circumference of the outer tube 2 when a predefined axial force is exceeded. This has the advantage that relatively smooth cylindrical guidance is achieved, which allows the two tubes 2, 3 to “telescope inside each other” at comparatively low friction, which is to say at a comparatively low force level (see FIG. 2).

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A torque transmission device, comprising:
an outer tube;
an inner tube, the inner tube being inserted a certain distance into the outer tube; and
a bonded joint configured to join the outer tube to the inner tube in a torque transmission direction and in a longitudinal direction of the outer tube, wherein the outer tube is joined to the inner tube exclusively via the bonded joint.

2. The torque transmission device according to claim 1, wherein a torsional rigidity of the outer tube is in a range of +/−10% of the torsional rigidity of the inner tube.

3. The torque transmission device according to claim 1, wherein a torsional rigidity of the outer tube is in a range of +/−5% of the torsional rigidity of the inner tube.

4. The torque transmission device according to claim 1, wherein the inner tube is bonded across an entire outer circumference thereof to an inner circumference of the outer tube over a predefined adhesive length measured in the longitudinal direction of the inner tube.

5. The torque transmission device according to claim 1, wherein a torsional rigidity of the outer tube equals a torsional rigidity of the inner tube.

6. The torque transmission device according to claim 4, wherein a torsional rigidity of the outer tube equals a torsional rigidity of the inner tube.

7. The torque transmission device according to claim 1, wherein
a peripheral recess is provided on an outer side of the inner tube, and
the recess is completely filled with an adhesive that forms the bonded joint.

8. The torque transmission device according to claim 6, wherein
a peripheral recess is provided on an outer side of the inner tube, and
the recess is completely filled with an adhesive that forms the bonded joint.

9. The torque transmission device according to claim 1, wherein
a peripheral recess is provided on an inner side of the outer tube, and
the recess is completely filled with an adhesive to form the bonded joint.

10. The torque transmission device according to claim 6, wherein
a peripheral recess is provided on an inner side of the outer tube, and
the recess is completely filled with an adhesive to form the bonded joint.

11. The torque transmission device according to claim 7, wherein
the recess is a turned or milled recess.

12. The torque transmission device according to claim 1, wherein
an outside diameter of the inner tube is identical to an inside diameter of the outer tube over the certain distance which the inner tube is inserted to the outer tube, except for a region in which a recess is provided in one of the inner or outer tubes.

13. The torque transmission device according to claim 7, wherein at least one through-hole opening into the recess is provided in the outer tube, whereby the adhesive fills the recess via the at least one through-hole.

14. The torque transmission device according to claim 9, wherein at least one through-hole opening into the recess is provided in the outer tube, whereby the adhesive fills the recess via the at least one through-hole.

15. The torque transmission device according to claim 1, wherein an adhesive forming the bonded joint is an adhesive that cross-links and expands when heat is supplied.

16. The torque transmission device according to claim 1, wherein the outer tube is made of steel or plastic material.

17. The torque transmission device according to claim 1, wherein the inner tube is made of steel or plastic material.

18. The torque transmission device according to claim 1, wherein one or both of the inner tube and outer tube are made of carbon fiber-reinforced plastic material.

19. The torque transmission device according to claim 18, wherein fibers of the outer tube extend in a circumferential direction of the outer tube or in a direction oblique thereto along a circumference of the outer tube in a region of the certain distance in which the inner tube is inserted into the outer tube.

20. A vehicle, comprising:
a propeller shaft, wherein
the propeller shaft has a torque transmission device comprising:
an outer tube;
an inner tube, the inner tube being inserted a certain distance into the outer tube; and
a bonded joint configured to join the outer tube to the inner tube in a torque transmission direction and in a longitudinal direction of the outer tube, wherein the outer tube is joined to the inner tube exclusively via the bonded joint.
